(19) United States
(12) Patent Application Publication
(10) Pub. No.: US 2006/0122544 A1
(43) Pub. Date: Jun. 8, 2006

(54) Therapeutic "smart" fabric garment including support hose, body garments, and athletic wear

(76) Inventor: Gary Ciluffo, Vincennes, IN (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/003,071

(22) Filed: Dec. 3, 2004

(51) Int. Cl. A61H 1/00

(52) U.S. Cl. 601/15; 601/21; 601/49; 601/79; 601/151

(57) ABSTRACT

Athletic and sports wear, and medical or therapeutic garments (G1-G8), all made from a “smart” fabric. The fabric is woven from, or incorporates, one or more components that allows the fabric to change size or shape, project heat or cooling to a part of the wearer's body, to monitor body vital signs such as temperature and pulse rate, etc. The fabric can be used in a garment covering only part of a patient's body, or substantially all of the body. Besides targeting specific areas of a body for treatment, garments made from the fabric facilitate zonal treatments; that is, areas of the body that require therapy but in which certain portions of the area require different levels or intensity of treatment than others. A variety of materials and their various capabilities are disclosed.

### CROSS REFERENCE TO RELATED APPLICATIONS

U.S. patent application Ser. No. 10/238,562 filed Sep. 10, 2002

### STATEMENT REGARDING FEDERALLY SPONSORED RESEARCH OR DEVELOPMENT

N/A

### BACKGROUND OF THE INVENTION

This invention relates to apparel including, but not limited to, compression hose, sports and athletic wear, shoes, and medical apparel such as a therapeutic body garment worn by people having circulatory or other medical problems, the apparel being fabricated from “smart” fabrics.

In co-pending U.S. patent application Ser. No. 10/238,562, there is described a support hosiery to be worn by elderly people or others having problems with blood circulation through their limbs. As described therein, the hosiery is loosely fitting when put on, but once on, can be tightened about a person's arm or leg, so to aid circulation through the limb. The initial looseness is advantageous in that many people cannot otherwise put the hosiery on, or take it off, without assistance from a nurse or family member. Further, the hosiery is designed to incorporate electrically conductive threads or fluid chambers such as air, water, or oil chambers so that constriction of the hosiery can be accomplished electrically or pneumatically. Further, by using the hosiery in conjunction with a monitor, the level of constriction in the hosiery can be automatically adjusted to the rate at which blood is pumped through the body, so to aid circulation through the limb.

It is well-known that medical or therapeutic garments are worn for other reasons than to improve circulation. Garments are worn, for example to apply pressure to an injured portion of the body where a muscle pull or bruise is located. Other garments are worn to insure that a heat pack or ice pack is kept in place at the site of an injury so to facilitate the patient's recovery. Those skilled in the art are aware of other examples.

Recent developments in materials technology have now made available “smart” fabrics having significant advantages over conventional cotton and polyester materials used in compression and support stockings, and other medical or therapeutic garments. These materials have shape retention capabilities which enable a garment to be custom fitted to a patient. But, in addition, these materials now offer new treatment modalities which have heretofore either not been available or have only been provided at significant expense and requiring a substantial amount of time to apply.

Further, the ability to integrate garments made from “smart” fabrics with control systems and patient databases, now allows a physician or therapist to readily customize a treatment regimen for a patient, monitor the treatment in real-time, modify the treatment as needed, and acquire patient data for analysis and future use as necessary.

### BRIEF SUMMARY OF THE INVENTION

The present invention is directed to athletic and sports wear and medical or therapeutic garments, all made from a “smart” fabric. The fabric is woven from, or incorporates, one or more components that allows the fabric to change size or shape, project heat or cooling to a part of the body, to monitor body signs such as temperature and pulse rate, etc. The fabric can be used in a garment covering only part of a patient's body, or substantially all of the body. Besides targeting specific areas of a body for treatment, garments made from the fabric facilitate zonal treatments; i.e., areas of the body that require therapy but in which certain portions of the area require different levels or intensity of treatment than others.

Among the smart fabrics employed in making the garments are materials which provide electrical or electronic impulses, pulsing or continuous electromagnetic stimulation, vibratory and sonic or ultrasonic wave generation throughout a defined frequency band and which can include both single or multiple frequencies, and others.

Garments made from one or more of the smart fabrics are capable of providing transcutaneous electronic nerve stimulation (TENS), magnetic therapy, prevent bedsores (decubitis), breakup calcium deposits in the body, enable defribillation of a person suffering from heart attack, short or long term traction or stretching, muscle stimulation, and non-surgical, drug-free treatments of diseases such as osteoarthritis. If a garment is made from more than one smart fabric, it can be used to perform more than one of these functions, including concurrent functions. Additionally, the garment can be used in conjunction with, or the fabric may include, a sensing capability so that various body activities can be monitored before, during, and after a treatment, thereby allowing a therapy or stimulation to be changed in “real time”. The garment can be attached or connected to, or in communication with, a small electronic controller or portable computer which provides the user complete mobility with information or therapy instructions, or commands, being transmitted via an rf or infrared link or the like. Additionally, the garment can be made to change colors to provide a sensor indication of changes in body signs such as blood pressure, heart rate, etc.

The garment can be worn only at certain times such as when sleeping or during therapy. The garment can also be conveniently worn beneath a person's clothing for prolonged periods of time, is washable, and can be worn numerous times without having to be replaced. The materials used in making the smart fabrics can include ceramics, shape-memory polymers including materials such as shape memory titanium alloys, mechanically active nanomaterials, materials with proprioception capabilities, piezoelectric, dielectric elastomers and electroactive polymer materials, electro-rheological fluids, metal rubber, materials such as Terfanol-D which convert electrical power to mechanical energy, nano-composites and nano-scale mesh materials, materials which attract or repel certain fluids, or a combination of these and other materials. Certain fabrics can incorporate pheromes so to produce various smells and fragrances, while others can produce infrared or ultraviolet light. Certain materials incorporating optical fibers can produce a color or range of colors in response to an input, and can change from one color to another within the range.

When incorporated into a garment, the capabilities of the materials are stimulated by external sources such as light, temperature, humidity, electrical, magnetic or other impulses, as well as by the wearer's body characteristics such as heart rate, blood pressure, body temperature, etc.

Other objects and features of my invention will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a representation of a human body shown wearing various garments of the present invention made with one or more smart fabrics;

FIG. 2 is a representation similar to FIG. 1 and wearing a full-body garment;

FIG. 3 illustrates a garment worn by a person susceptible to a heart attack and incorporating material by which an electrical stimulus can be applied if a heart attack occurs;

FIG. 4 illustrates another embodiment of the invention in which a garment worn by a bedridden person enables the body to be stimulated so bedsores do not occur;

FIGS. 5 and 6 illustrate the woof and warp of a smart fabric made using or more materials with unique properties;

FIG. 7 illustrates a characteristic of a fiber in a smart fabric to change its size under certain conditions; and,

FIG. 8 illustrates a portion of garment by which a zonal treatment is affected on a part of a patient's body.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

Referring to the drawings, the present invention is directed to a therapeutic garment G which is manufactured from a smart fabric. By a smart fabric is meant a fabric that has features which allow it to be more than just a covering when worn by a patient P. That is, the characteristics of the fabric can change when subjected to a stimulus which can be to the wearer (light, temperature, electrical, magnetic, sonic, etc. inputs) or internal (blood pressure, heart rate, etc.), and this change is efficacious in the treatment of a patient, whether the treatment is short term, or episodic, or long term. By wearing a garment made from the smart fabric, the patient is more readily treated, and is easier to treat. It also makes the treatment more efficient for the doctor or therapist, and allows the treatment to continue when the patient is away from the doctor's office or treatment site. This ability to give continuous treatment provides the patient more flexibility in his or her activities, even allowing them to perform activities which have necessitated the need for treatment in the first place.

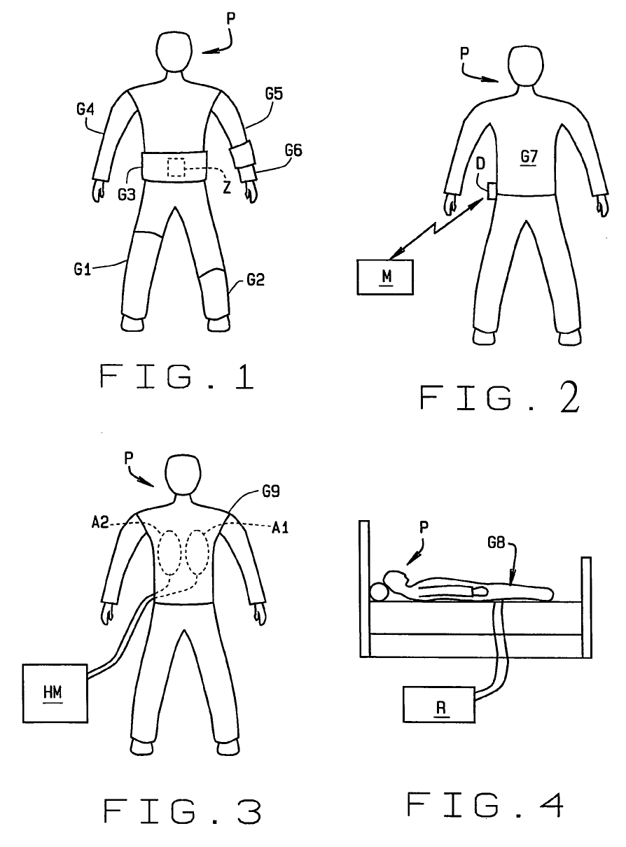

As shown in FIGS. 1 and 2, a garment G of the present invention is available in a number of different sizes and shapes. In FIG. 1, a garment G1 comprises a hose which the patient wears and which can be used to improve blood flow through the lower extremity. A garment G2 comprises a support worn over the ankle to support a strain, for example, thereby eliminating the need for a hard (plaster) or soft cast. Importantly, the support hose is self-adjusting making it easier for the wearer to put it on, or take it off, without assistance. Those skilled in the art will understand that garment G2 can be used on any extremity (arm or leg) and can be contracted as necessary to apply the appropriate amount of pressure to the limb to support the limb.

A garment G3 comprises a girdle which can be used for lower back support or the like. Garment G4 comprises a sleeve extending from the wrist to the shoulder, while garments G5 and G6 are upper arm and lower arm cuffs respectively. In FIG. 2, a garment G7 is shown to be a whole body garment. All of the garments G1-G7 can be conveniently worn beneath street clothes, or beneath athletic and sports apparel or the like.

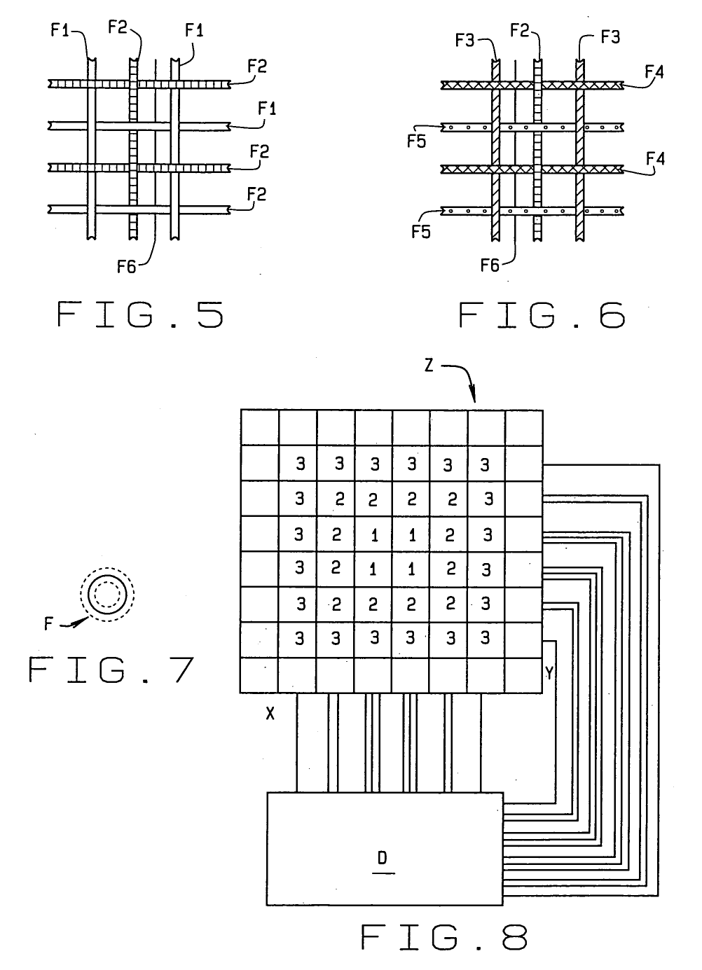

Referring to FIGS. 5 and 6, the smart fabric from which the garments G are made includes one or more strands of fibers having unique characteristics or properties. Certain fibers are, for example, heat sensitive and respond to the body's temperature to expand or contract. Other fibers are responsive to an electrical current or the presence of a magnetic field to change size or shape. As shown in FIG. 7, a fiber F may be of a first diameter (shown in solid line) under certain circumstances, but when subjected to a stimulus may expand (shown in dashed line), or contract (shown in dotted line). Those skilled in the art will understand that FIG. 7 is exemplary only, and that it is a feature of the invention that the smart fabric employed in the garment have targeted characteristics including the ability to deform, as shown in FIG. 7, or otherwise change in response to an input such as an electrical current, magnetic field, sound or acoustic wave, light intensity, sensed changes in room temperature and/or humidity. Inputs which can also trigger a change in the target characteristics of the fabric further include a patient's “vital” signs including blood pressure, heart rate, body temperature, and muscle movement. If the fabric has color capabilities, a change in body temperature, for example, can be observed by a change in the color of the fabric in those areas where a change occurs.

As shown in FIGS. 5 and 6, fibers of particular materials used to make the smart fabric can comprise the woof and warp of the material from which a garment G is made. In the weave shown in FIG. 5, a conventional fiber F1 is interwoven with a fiber F2 for a smart fabric material. In the weave shown in FIG. 6, multiple fibers F2-F5 for separate smart fabric materials are interwoven. The particular fibers used, and the pattern in which they are interwoven, are a function of the purpose for which a garment G is to be worn. It will be understood by those skilled in the art that it may be advisable to use similar fibers, but with different characteristics (for example, one stretches more than the other, or one generates a greater magnetic field when subjected to a current) so that the range of treatment available using the garment is increased. In addition, fibers such as fiber F6 may be incorporated into the weave to provide a sensing or feedback capability. This is because it is an important aspect of the invention that the wearer of a garment G no longer has to be connected or tethered to a piece of equipment such as a monitor in order to be treated for a condition. As shown in FIG. 2, a communications and control device D is worn with the garment. The device communicates with a monitor M using an rf link, infrared or similar optical signals, sonic waves or the presence or absence of an electromagnetic field.

Depending upon the smart fabrics used in an above described garment, the garment, when worn, will provide one more of the following functions:

It can provide transcutaneous electronic nerve stimulation to activate one or more muscles. As such it can be used maintain a desired level of fitness which is important particularly among older people or people tending to infirmity. In this latter regard, it is known that even a very mild degree of exercise has substantial impact on an aging person's overall well-being.

It can place magnets near a person's joints so the joint is affected by a magnetic field. Or, the fabric can include electromagnets which are energized by the application of an electric current. It the latter instance, the field can be turned on and off by providing a pulsed electric current and the intensity of the field can be controlled by the characteristics of the pulses.

It can transmit sound waves through the person's skin and direct the waves toward a person's joints so to break up or prevent the formation of calcium deposits.

It can produce light in either the infrared or ultraviolet portion of the spectrum and is useful in therapies employing such light.

It can contract and/or expand in both the woof and warp directions to achieve a number of beneficiary results. One is to massage a painful area to alleviate pain or nervous tension. Expansion and contraction of the material can be done over a defined period of time depending, for example, on the extent of the bruised or injured area. In the limbs, contraction and expansion improves blood flow through the limbs. It has been speculated in this regard that this action produces a “vibratory” sensation which may prove beneficial to people suffering from angina. Further, as shown in FIG. 4, a bed-ridden patient can be clothed in a full body garment G8. The garment is connected to controller R which periodically causes different portions of the garment to expand and contract. Not only does this promote blood flow through the arms and legs, but by performing this operation of the entire body, it prevents pooling of the blood in the lower portions of the body and decreases the risk of decubitis.

It can change color in response to a person's body signs. A garment G7, for example, could be completely made of a temperature sensitive fabric so that, when worn, the garment, in effect, represents a thermal image of the wearer. Such an image can provide medical personnel instantaneous whole-body information as to blood flow, the location of clots or growths, etc., negating the need for, or supplementing MRI's and other types of body scans.

It can be used to set or monitor alarms which alert medical personnel to a change in the wearer's condition. For example, rapid flexing and relaxing of the fabric could signal a shortness of breath and the need for oxygen to be supplied to a patient.

It can include certain types of medications which, under defined conditions, are released into the body through the skin. Anti-inflammatory and arthritis medications, and analgesics and other asthmatic and allergy medications, for example, can be incorporated into apparel so to make it easier for someone to go outdoors when they otherwise could not, or walk, run, and engage in sports without having to carry medications with them. Fabrics can incorporate various pherones emitting different odors under various conditions so to, in effect, provide aromatherapy to the wearer.

Another feature of an expandible/contractable garment is that it can be used to hold a limb or muscle in a desired position over a period of time, so to prevent otherwise painful movement and promote healing.

Referring to FIG. 3, a garment G9 comprises a vest which is worn by someone known to have a heart condition or to be susceptible to a heart attack or heart failure. In the garment, a fabric including electrodes is woven into the areas A1, A2 which are located over the portions of the body where paddles would be placed by a medical technician or doctor were the patient to go into cardiac arrest and need to be revived. The garment is connected to a heart monitor HM. If the patient were to “flatline”, the monitor would first check to make sure that an electrical shock can and should be applied to the patient; and if warranted, apply the current through the electrodes woven into the garment. The garment insures that the electrodes are properly located and saves a critical amount of time in application of the current. It also frees the doctor or technician to do other vital tasks which may need to be done.

Finally, as shown in FIG. 8, a garment can include one or more zones Z previously referred to. Each zone may be spatially separated from another zone, or zones may be contiguous. Further, a zone may cover a small to large area of the wearer's body depending upon the type of treatment the wearer is to receive. It effect zonal treatment, the threads woven through the zone portion of the garment are connected to communications and control device D. The respective woof and warp threads define a unique address or location within the zone. By applying an appropriate input to both the woof and warp threads, each unique location within the zone will have a combined value representing the level of treatment to be applied at that location.

For example, assume that the locations indicated “1” in the zone are to have the most intense level of treatment, the locations “2” a slightly less intense level, and the locations “3” the least intense. For convenience, X and Y are used to denote location co-ordinates within the zone. To achieve the least intense level of treatment, a low level input is applied to the threads denoting the level “3” intensity, a slightly higher level input is applied to the threads denoting the level “2” intensity, and the highest level input is applied to the threads denoting the level “1” intensity. The level and timing of treatment at each location can be adjusted real-time by controller D. Importantly, the level of intensity can be shifted over time within the zone by the controller. So, as shown in FIG. 8, the levels of intensity can be shifted up and down, right to left, diagonally, or in a circle. If zones are located contiguous to one another, then the intensity levels can also be shifted from one zone to the next.

In view of the above, it will be seen that the several objects and advantages of the present invention have been achieved and other advantageous results have been obtained.

Having thus described the invention, what is claimed and desired to be secured by Letters Patent is:

1. A garment worn for therapeutic purposes comprising a web of material sized and shaped to fit over and cover at least a portion of a wearer's body, the web of material being formed of a fabric exhibiting at least one characteristic responsive to a stimulus so, when the garment is worn, the portion of the body covered by the garment is affected by the characteristic thereby allowing the wearer to receive a therapeutic treatment for a condition from which the wearer suffers.

2. The garment of claim 1 in which the fabric is formed from at least one material having the characteristic.

3. The garment of claim 2 in which the fabric is formed of a least separate materials each of which has a separate characteristic, the characteristics complimenting each other to provide the therapeutic treatment.

4. The garment of claim 1 which covers one or more of a wearer's limbs.

5. The garment of claim 4 which substantially covers the wearer's torso.

6. The garment of claim 5 comprising a cuff.

7. The garment of claim 6 comprising a girdle.

8. The garment of claim 2 in which the fabric includes a material from one of the following groups of materials: ceramic, shape memory polymer, electroactive polymer, mechanically active nano-materials, proprioception materials, piezoelectric, dielectric elastomer, electro-rheological fluid material, metal rubber, nano-composite, nano-scale mesh, pherome incorporating materials, fluid repellant material, and materials which produce colors in the ultraviolet, visual, or infrared portions of the light spectrum and which can change from one color to another.

9. The garment of claim 8 in which the fabric is formed from at least two of the materials from the groups of materials.

10. The garment of claim 1 in which the fabric provides transcutaneous electronic nerve stimulation in response to a stimulus.

11. The garment of claim 1 in which the fabric produces a magnetic or electromagnetic field in response to a stimulus.

12. The garment of claim 1 in which the fabric can be tightened and relaxed in response to a stimulus to improve blood circulation through the limbs, and prevent decubitis in bedridden people.

13. The garment of claim 1 in which the fabric is electrically conductive and provide an electrical stimulation to a part of the body in response to a stimulus.

14. The garment of claim 13 in which the fabric is incorporated into a garment used to provide an electrical shock to the wearer to induce heart defribillation in a person suffering a heart attack.

15. The garment of claim 1 in which the fabric provides a sensing function by changing its characteristics in response to a change in the garment wearer's physical condition, the fabric providing an output to a monitor.

16. The garment of claim 15 in which the physical condition monitored by the fabric includes body temperature, heart rate, blood pressure, muscle contraction and relaxation.

17. The garment of claim 1 in which the stimulus to which the fabric responds to provide the therapeutic treatment includes electrical stimulation, the presence of a magnetic field, vibration, sonic and ultrasonic sounds, a rf signal, ultraviolet or infrared light inputs, a change in temperature, pressure, and/or humidity, fluid flow, odors, or a combination of two or more of the above.

18. The garment of claim 1 which can be worn beneath the wearer's other garments, for the garment to be used to provide a treatment to the wearer under normal living conditions.

19. The garment of claim 1 further including communication means by which the garment provides information to a remote monitor of the wearer's condition, the remote monitor providing an input to the garment to stimulate the fabric to initiate, modify, or terminate a therapy in response to the information transmitted from the garment.

20. The garment of claim 8 in which the fabric provides a zonal treatment capability by which, when a region on the wearer's body is being treated, one zone within that region can receive one level of treatment, and a separate zone within the body can receive a different level of treatment.
